(19) United States
(12) Patent Application Publication
(10) Pub. No.: US 2026/0339891 A1
(43) Pub. Date: Oct. 29, 2026

(54) SELF-LEARNING MODULE FOR ADAPTIVE INDEXING AND RETRIEVAL IN DISTRIBUTED NETWORKS

(71) Applicant: Dell Products L.P., Round Rock, TX (US)

(72) Inventors: Avinash Kumar, Bihar (IN); Gururaj Kulkarni, Bangalore (IN); Shelesh Chopra, Bangalore (IN)

(21) Appl. No.: 19/193,642

(22) Filed: Apr. 29, 2025

(51) Int. Cl. G06F 16/14; G06F 16/16; G06F 16/182; G06F 40/247; G06F 40/284; G06F 40/40

(52) U.S. Cl. CPC G06F 16/148; G06F 16/164; G06F 16/182; G06F 40/247; G06F 40/284; G06F 40/40

(57) ABSTRACT

An AI-driven indexing framework for probe-based backup systems that enables intuitive, context-aware search and real-time metadata categorization using natural language processing (NLP) to improve accessibility and simplify searches in a distributed system. An adaptive indexing system optimizes searches in the system by dynamically re-indexing files based on real-time access patterns, ensuring faster file retrieval and user-friendly interaction. A feedback loop provides continuous improvement by continuously collecting data about access trends and system usage behavior, and modifying the index using the collected data to adapt the indexing to changing data patterns.

### TECHNICAL FIELD

Embodiments are directed to distributed deduplication file systems, and a self-learning module for AI-driven intelligent indexing for efficient probe-based backup retrieval.

### BACKGROUND

A distributed (or cluster) file system is a type of file system in which data is spread across multiple storage devices as may be provided in a cluster of nodes. Each computer forms a node in the system and runs its own instance of an operating system. The file system is shared by being simultaneously mounted on multiple servers, and presents a global namespace to the nodes so that files appear to be in the same central location. Distributed file systems are typically very large and may contain many hundreds of thousands or even many millions of files, as well as services (applications) that use and produce data. The Santorini file system provided by Dell Technologies, Inc. represents a type of cluster network system that stores the file system metadata on a distributed key value store and the file data on object store. The metadata can be accessed by any front-end node, and any file can be opened for read/write by any front-end node.

In large-scale multi-node infrastructures, the exponential growth of backup data across Virtual Machines (VMs), Network-Attached Storage (NAS), filesystems, and so on, poses significant challenges for efficient indexing and retrieval. Traditional indexing mechanisms struggle to keep pace with the increasing scale and complexity of backup datasets, leading to slow file access and retrieval times. These delays are especially critical during recovery operations, where quick access to data is vital to avoid downtime or data loss.

The problem is further complicated in distributed environments, where backup data is often spread across multiple nodes. This fragmentation can cause inconsistencies in indexing, making it difficult to maintain synchronized metadata and exacerbating retrieval delays. Recovery operations in such environments also strain existing systems as they require navigating complex hierarchical structures while ensuring accuracy. Static indexing models often fail to adapt to dynamic workloads and changing access patterns, resulting in inefficient resource utilization. The retrieval process is hindered by the inability to prioritize critical data or effectively process metadata from diverse sources. These challenges highlight the need for a more efficient approach to indexing that ensures rapid and reliable access to backup data while maintaining data consistency across distributed environments.

These problems can become especially critical during time-sensitive recovery operations, such as recovering from a system outage or total failure. For example, a financial institution needing to recover critical transaction logs during a system outage cannot tolerate traditional systems that struggle to prioritize and retrieve such logs efficiently, as delays can badly impact business continuity.

What is needed, therefore, is an intelligent, self-learning system that can adapt to real-time data patterns and optimize indexing for faster data retrieval and system recovery.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell, Data Domain, and Santorini are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing an intelligent indexing process for cluster networks, under some embodiments.

FIG. 2 illustrates a high-level overview of a network cluster using the Santorini architecture, under some embodiments.

FIG. 3 illustrates details of the services related to the data path running in Santorini cluster network, under some embodiments.

FIG. 4 illustrates a system for indexing and searching backup data that includes an intelligent indexing process, under some embodiments.

FIG. 5 is a block diagram illustrating functional components of an intelligent indexing processing component, under some embodiments.

FIG. 6 is a flowchart that illustrates a method for indexing and searching backup data using an intelligent indexing process, under some embodiments.

FIG. 7 illustrates an AI-driven intelligent indexing system for probe-based backups, under some embodiments.

FIG. 8 illustrates a data ingestion and metadata extraction subcomponent, under some embodiments.

FIG. 9 illustrates a data ingestion and metadata extraction process, under some embodiments.

FIG. 10 illustrates an NLP interface and operation, under some embodiments.

FIG. 11 is a flowchart illustrating a method of retrieving files using AI-driven intelligent indexing, under some embodiments.

FIG. 12 illustrates an overall intelligent indexing system for probe-based backups in a clustered system, under some embodiments.

FIG. 13 illustrates a reinforcement learning module for intelligent dynamic indexing, under some embodiments.

FIG. 14 illustrates continuous update of RL model policies using feedback, under some embodiments.

FIG. 15 is a block diagram of a computer system used to execute one or more software components for the distributed system of FIG. 1, under some embodiments.

### DETAILED DESCRIPTION

A detailed description of one or more embodiments is provided below along with accompanying figures that illustrate the principles of the described embodiments. While aspects of the invention are described in conjunction with such embodiments, it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

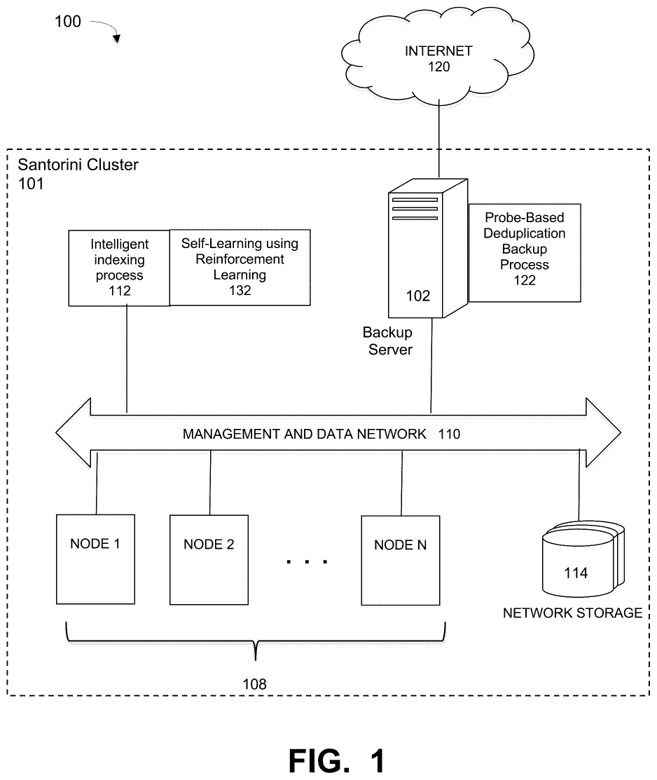

FIG. 1 is a block diagram illustrating a distributed system implementing an intelligent indexing process for efficient probe-based backups, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster system, cluster file system, or cluster network) typically consists of various processing components that run in different computer systems (nodes) that are connected to each other. These components communicate with each other over the network via messages and based on the message content, perform certain acts like reading data from the disk into memory, writing data stored in memory to the disk, perform some computation (CPU), sending another network message to the same or a different set of components and so on. These acts or ‘component actions,’ when executed in time order in a distributed system constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case network 101 supports various related file system and data managers, such as PowerProtect Data Manager (PPDM), as well as services such as ObjectScale object storage and other services.

In an embodiment, network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Although embodiments are described in the context of Data Domain file system (DDFS) and a Santorini cluster system, embodiments are not so limited and any architecture that requires a distributed logging service within given, configurable resources may be used.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment, cluster network 101 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

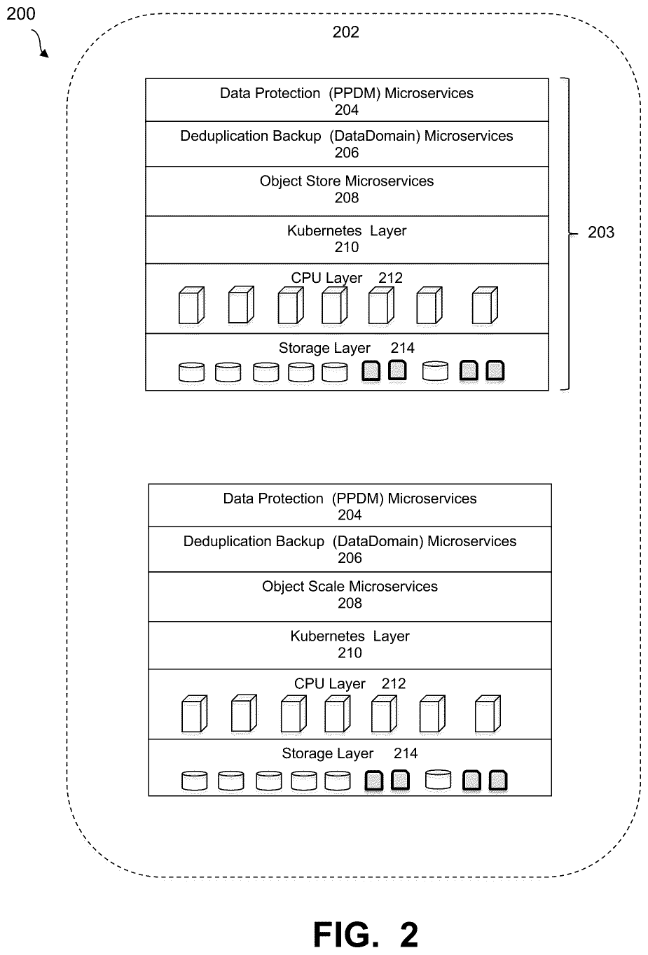

FIG. 2 illustrates a high-level overview of a network cluster using the Santorini architecture, under some embodiments. In system 200 of FIG. 2, a two-node cluster 202 is shown. Each node 203 consists of several distinct components or processing layers. For the example shown, a node includes a PowerProtect Data Manager (PPDM), or similar microservices layer 203, a Data Domain (deduplication backup) appliance microservices layer 206, an object storage (e.g., Dell ObjectScale) microservices layer 208, a Kubernetes layer 210, a processor layer 212, and a storage layer 214 including different types of storage media, such as HDD, Flash memory, SSD memory, and so on. Each of these component products consists of multiple microservices, and as more nodes are added, Santorini scales CPU, storage, RAM, and networking accordingly. Other layers can also be included, and a cluster 202 may comprise any practical number of nodes 203. The PPDM represents a cloud-native data protection manager system, and ObjectScale represents a scalable object storage manager.

As shown in FIG. 2, embodiments of the cluster network 200 through DD microservices 206 utilize Data Domain backup appliances to provide streaming deduplication, and which use the Data Domain File System (DDFS) as an inline data deduplication file system. As data gets written to the file system, DDFS creates variable sized segments and writes the unique segments to a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

As generally understood, “metadata” refers to system data or information that comprises descriptive information about data, such as file types, sizes, access patterns, and change rates, used to categorize and index files for efficient retrieval.

In a deduplicated file system that forms segments from data, these segments are uniquely identified by their key/label called a ‘fingerprint.’ Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

With respect to the directory tree structure of the data processed in system 100, various different data structures can be supported by the file system (e.g., DDFS or Santorini file system). A B+ Tree is self-balancing tree structure and is a variant of a standard B Tree, and Each file inode is stored in the B+ Tree as a data blob using the parent directory inode number and the child file inode number as the key. A B+ Tree key structure composed of the parent directory inode as the primary key and child file inode as the secondary key to construct the full key. An Mtree is a tree data structure similar to a B+ Tree (or R-tree), which is constructed using a metric and relies on triangle inequality for efficient range and k-nearest neighbor queries. As with other tree-based data structures, the Mtree is composed of nodes and leaves. In each node there is a data object that identifies it uniquely and a pointer to a sub-tree where its children reside. Every leaf has several data objects

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+ Tree. The L0 and Lp segments are written to separate containers, known as L0 and Lp containers.

A Data Domain or similar system can efficiently copy an existing file using the same underlying Merkle tree. It creates the new file with a new name, and therefore a new L6 root of the tree, but that tree then references the identical LP chunks. As this operation involves only the root of the tree, it is trivially fast and does not increase physical space in use beyond the one chunk containing the L6.

In an embodiment, the PPDM (PowerProtect Data Manager) microservices layer 204 builds on the Data Domain system 206 to provide data protection capabilities for VM image backups and Kubernetes workloads.

Upon creation of an Mtree, it can identify the domain on which the Mtree is created. All namespace metadata as well as the file data and metadata associated with a Mtree is allocated from resources owned by that domain. The Mtree names as well as Mtree IDs are unique across the cluster. Santorini exposes a global namespace that is a union of all namespaces in all domains.

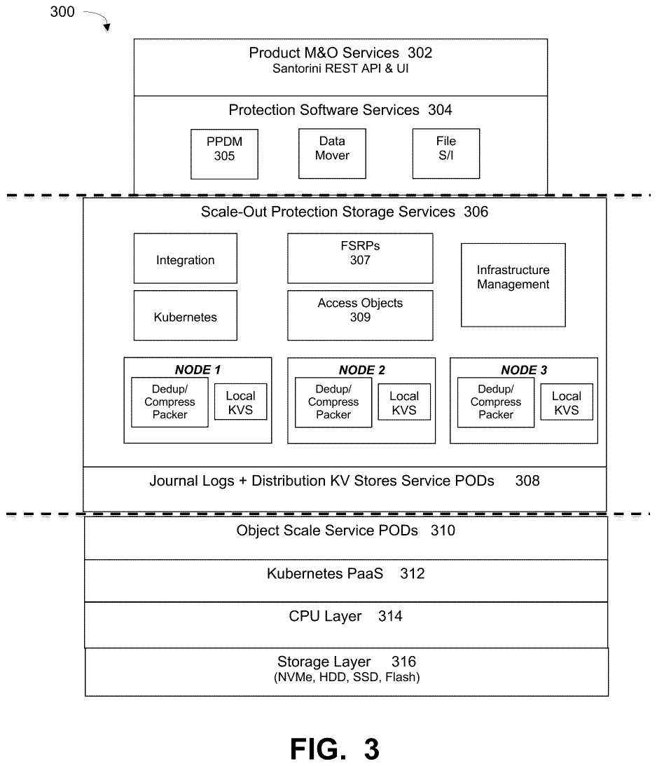

FIG. 3 illustrates details of the services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks. Also included in layer 306 are any number of nodes (e.g., Nodes 1 to 3, as shown), each containing a dedup/compression packer and a key-value (KV) store.

As an L1 is formed, a similarity group (simgroup) is calculated for the L1 based on the SHA1 fingerprints of the L0 segments (or other properties). The similarity group is checked against a mapping table, which leads to consistently routing the L1 based on its similarity group to an instance of a node's dedup/compress service. If similarity groups are in a range of 0-1023, then if there are four instances of the dedup/compress service, then the instances may uniquely be responsible for the ranges 0-255, 256-511, 512-767, 768-1023, though other mappings are possible. The dedup/compress instance will deduplicate the L0 segments relative to other fingerprints within the same similarity group. Other functionality exists in the dedup/compress service such as packing segments into compression regions, containers, and blobs that will be written to an underlying object storage such as provided by the object scale service layer 310, or an object store provided by the public cloud. Other layers of system 300 include a Kubernetes PaaS (platform as software) 312, a CPU layer 314, and a storage layer 316.

Distributed key value stores in 308 are also a component of Santorini and are used to hold much of the metadata such as the namespace Btree, the Lp tree, fingerprint index, and container fingerprints. These run as containers within the Santorini cluster and are stored to low latency media such as NVMe 316. There is also a distributed and durable log that replaces NVRAM for Santorini.

In summary, Santorini is an integrated scale out software solution developed by Dell Technologies that can run on-premises or in a public cloud. In an embodiment, the Santorini stack consists of PPDM as backup software, Data Domain scale out file system, and Object Scale as a storage pool, and these are run as services inside the Kubernetes container infrastructure. The Santorini scale-out file system consists of stateless independent Data Domain services which are responsible for data path. The state of Santorini file system is maintained in three components wherein data is put in object scale, metadata is stored in a distributed key value store (KVS), and logs are stored in a distributed log. The metadata and data can be logged at different rates by the various layers and components of system 300, thus adding complexity to the task of providing a synchronized point for crash recovery using these logs.

### Intelligent Indexing Process for Probe-Based Backups

As shown in FIG. 1, network 101 includes an intelligent indexing process 112 for probe-based backup file retrieval. Process 112 may be a process executed by a specially configured management or control node in system 100. Alternatively, it may be executed as a server process, such as by server 102 or any other server or client computer in the system.

Embodiments are thus directed to probe-based backup systems 122, which are systems where a dedicated “probe” or script is run on a system to determine if a backup should be initiated, meaning the backup only occurs when specific conditions identified by the probe are met, essentially acting as a trigger for the backup process. This is often used in conjunction with backup software like Dell EMC NetWorker, where the probe can check specific system parameters before initiating a backup. Unlike traditional scheduled backups, probe-based backups only run when the probe determines it is necessary based on specific criteria. The probe can be designed to check various conditions like system health, application status, or specific file changes, allowing for tailored backup strategies.

A probe-based backup is also a type of event-based backup, as the probe acts as a trigger based on a specific event occurring. In the context of Dell EMC NetWorker backup software, a “probe action” can be configured to execute a custom script or command on a client to determine if a backup should proceed. Probe-based backup systems can also be used to perform database consistency checks, where a probe could run a database integrity check before initiating a database backup to ensure that only consistent data is backed up. It could also provide application status monitoring, where a probe could check if a critical application is running and only backup data if the application is currently operational, or file modification detection where a probe could scan for newly created or modified files and only backup those specific files if needed; and other similar applications.

As stated above, as backup data in multi-node environments continues to grow exponentially, existing probe-based backup systems encounter the current limitations of traditional indexing techniques. These include problems in handling the increasing scale and complexity of modern backup datasets, resulting in slow file retrieval times and inefficiencies when searching for individual files within massive backup sets. This challenge becomes even more profound during time-sensitive recovery operations, where delays in file retrieval can significantly impact business continuity. Embodiments of process 112 help enhance indexing performance and accuracy in probe-based backup systems, while reducing resource consumption in multi-node backup environments during file retrieval and recovery operations.

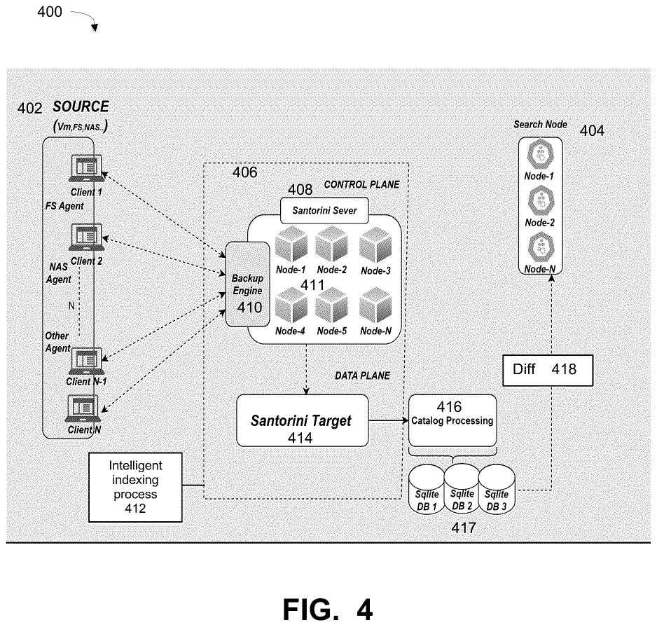

FIG. 4 illustrates a system for indexing and searching backup data that includes an intelligent indexing process that helps overcome critical challenges in adaptability and efficiency in multi-node environments processing large backup datasets. As shown in FIG. 4, system 400 includes a number (N) of data sources 402 embodied as network clients (e.g., Client 1, Client 2, . . . , Client N) which can comprise file system agents, NAS agents, or other similar agents. The data from the sources 402 is backed up by a backup engine 410 of cluster network 406, which services the various nodes 411 of the network as controlled (over a control plane) by a server (e.g., Santorini server) 408 for a target 414 over a data plane. Search nodes 404 can conduct searches of the backup data and a catalog process 416 stores appropriate index data in databases 417, which is then processed through a differencing process 418.

In general, the diff process operates by comparing newly ingested metadata against previously indexed data to detect delta changes across backup cycles. This includes evaluating changes in file content, metadata attributes (e.g., access time, ownership, size), and ACL modifications. The diff algorithm leverages hash-based fingerprints (e.g., SHA-256) and vector similarity scores (e.g., cosine similarity) between previous and current vector embeddings. When significant deviation or unauthorized change patterns are identified, the system flags the associated file as a high-priority candidate for re-indexing. The differencing process is optimized through heuristic thresholds for change detection, minimizing reprocessing of unchanged data while maintaining index freshness and consistency across nodes.

Present systems typically depend on static indexing architectures that are designed to handle predefined data structures but lack the flexibility to adapt to dynamic and evolving workloads. As stated previously, when backup datasets increase in size and complexity, the performance of these static systems begins to degrade. Static indexing structures are not optimized for handling distributed data across multi-node environments, where the fragmentation of backup data further complicates retrieval. This results in significant delays in search times, as the system struggles to sift through large and often unorganized datasets. Additionally, as the indexing process does not dynamically prioritize frequently accessed or critical files, inefficiencies in resource utilization increases the problem, further hindering system performance. Embodiments of system 400 include an intelligent indexing process 412 that provides an adaptive, scalable indexing system that can efficiently accommodate the demands of growing data volumes from sources 402 in network 400.

In an embodiment, component 412 of system 400 provides a Natural Language Processing (NLP) based interface for an AI-driven indexing framework created for probe-based backup systems that enhances data management using machine learning algorithms.

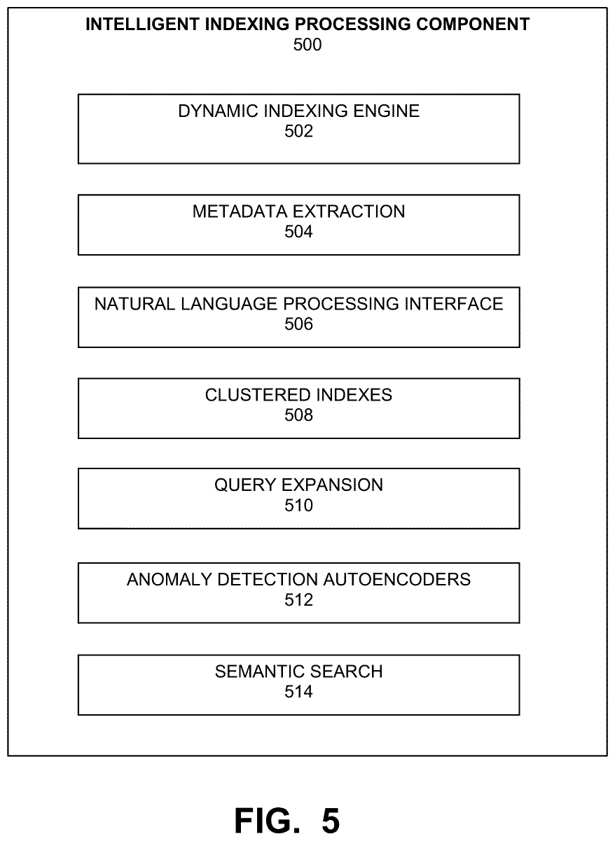

FIG. 5 is a block diagram illustrating functional components of an intelligent indexing processing component, under some embodiments. As shown in FIG. 5, system 500 includes several sub-components or sub-processes that provide an AI-driven indexing framework for probe-based backup systems. The intelligent indexing processing component includes a dynamic indexing engine 502 that is an adaptive system that updates file indexes in real-time based on usage patterns and access frequency to optimize search efficiency. A metadata extraction 504 automatically identifies key attributes of returned files, such as file size, type, and access history for efficient indexing.

With respect to an actual index, each file indexed during the probe-based backup process is represented as a structured metadata record enriched with semantic and contextual attributes. For example, consider a file located at/project/docs/financial/Q2_Report.xlsx. This file is classified as “Confidential” and accessed frequently (e.g., 20 reads per day average), and updated moderately (e.g., 3 times in the last 7 days). The file's Access Control List (ACL) shows read/write permissions for the user admin and read-only access for the finance group. To support natural language searches, the file is transformed into a vector embedding, such as [0.321, 0.114, 0.986, . . . ], which is stored in the NLP vector database. Additional metadata such as last modified timestamp (e.g., 2025-04-20T18:32:00.000Z) and anomaly status (e.g., normal) are also recorded. This indexed representation enables fast retrieval through semantic queries like “Find all confidential financial documents modified last week by finance team members.”

The NLP interface 506 is a user-facing system allowing natural language queries for more intuitive and precise file searches. The NLP interface enables users to interact naturally with the system, allowing intuitive search capabilities through natural language queries. It also includes several key subcomponents, starting with data ingestion and metadata collection, where metadata is classified using labelled tags such as “confidential,” “internal use,” etc., access patterns, change rates, ACLs (user/group access control lists), sizes, and file types, and that is collected during the probe-based backup process using client-specific agents integrated into the Santorini server. For example, in a probe-based backup system, if critical data is being frequently accessed or modified, the backup server can configure the probe to identify such modifications or access patterns. This ensures that the file system (FS) containing the critical data is protected and indexed. The metadata, including these access or modification patterns, is then utilized by the search cluster to enable quick and efficient search via the NLP-based interface.

System 500 also includes clustered indexes, 508, which are distributed indexing structures that are synchronized across multiple nodes to maintain consistency and improve search speed. A query expansion module 519 enhances user searches by incorporating related terms and metadata to broaden and refine search results. Autoencoders 512 comprising neural networks used for unsupervised learning are trained to detect anomalies by learning efficient representations of data and identifying deviations from normal patterns. A semantic search component 514 understands the meaning behind user queries, and recognizes synonyms and context for more accurate results.

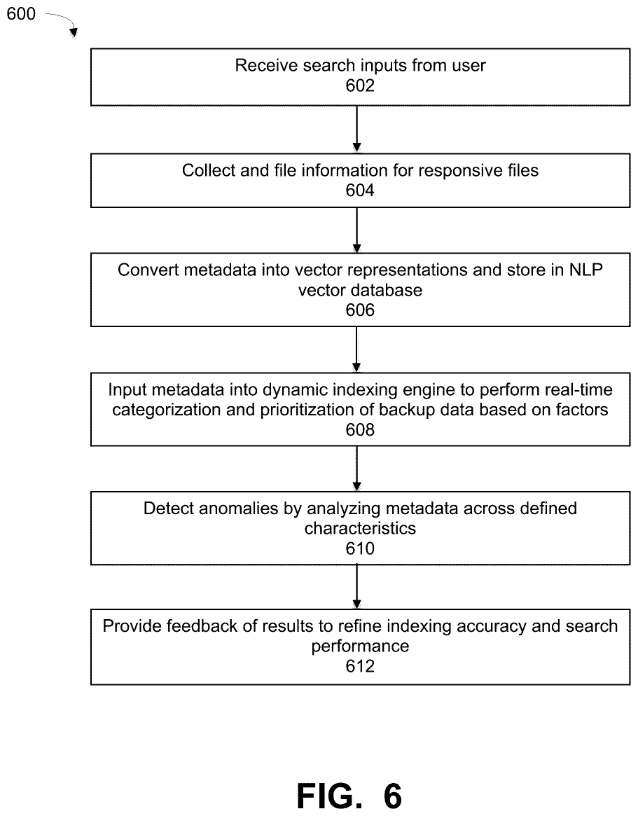

FIG. 6 is a flowchart that illustrates a method for indexing and searching backup data using an intelligent indexing process, under some embodiments. Process 600 of FIG. 6 begins with receiving search inputs from a user, 602. In response to these search inputs, one or more responsive files are returned, and metadata is collected along with the file information for these responsive files, 604. The metadata is processed and converted into vector representations, which are then stored in an NLP vector database, 606. This database serves as the foundation for enabling efficient search capabilities, allowing complex queries to be executed and facilitates fast and accurate extraction of relevant data.

As generally understood, a vector representation is mathematical representation of data (e.g., metadata) in a multi-dimensional space, enabling efficient storage, retrieval, and similarity comparisons in AI-driven systems.

In step 608, the metadata is input into the dynamic indexing engine 502, which leverages machine learning to perform real-time categorization and prioritization of backup data based on certain defined factors, such as access frequency and usage trends.

To ensure data integrity, the framework incorporates an anomaly detection mechanism 512 that identifies potential issues like data corruption or unauthorized changes, to increase the reliability of recovery points 610. These issues are detected by analyzing metadata across certain characteristics, such as change rates, unusual access patterns, or irregular modification patterns, among others. For example, a sudden spike in the change rate of critical files or access from unverified sources could indicate potential corruption or unauthorized activity, triggering an alert for corrective actions.

Additionally, a feedback loop is used to feedback results for continuous improvement 612. This captures user interactions and insights to refine indexing accuracy and search performance over time.

By integrating the components of FIG. 5, the process 600 of FIG. 6 provides an adaptive and intelligent method for efficient backup file indexing and retrieval, significantly improving data accessibility, operational efficiency, and security in multi-node environments.

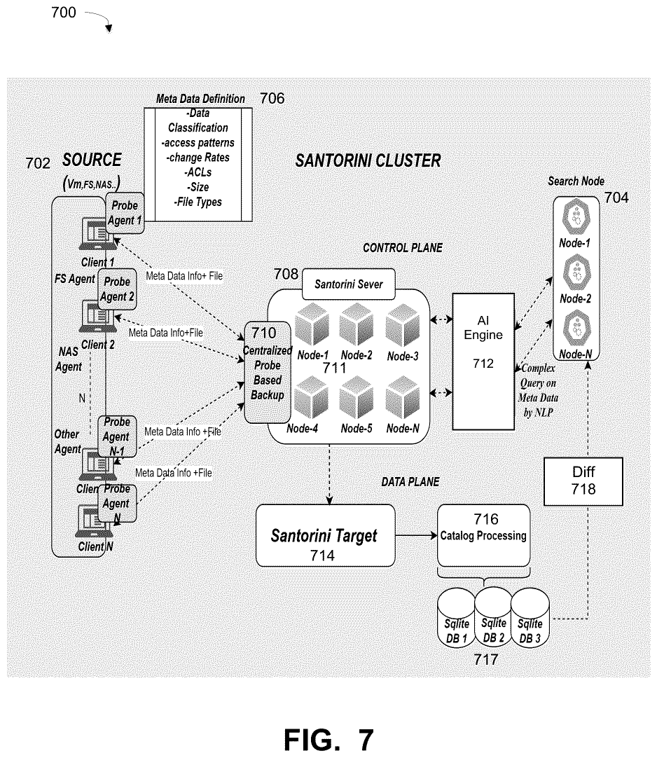

FIG. 7 illustrates an AI-driven intelligent indexing system for probe-based backups, under some embodiments. System 700 includes a number (N) of data sources 702 embodied as network clients (e.g., Client 1, Client 2, . . . , Client N) along with respective probe agents (Probe Agent 1, Probe Agent 2, . . . , Probe Agent N). The data from the sources 702 is backed up by a centralized probe-based backup engine 710 for nodes 711 served by Santorini server 708 over a control plane. The centralized probe-based backup engine 710 sends and receives metadata info and file data from the respective clients 702 through their respective probe agents. The metadata definitions 706 include data classification, access patterns, change rates, access control logic (ACL) size, file type, and other appropriate characteristics.

Backup data from the nodes 711 is sent to the backup (Santorini) target 714 over the data plane and a catalog processing unit 716 transmits the data to database storage 717.

In an embodiment, AI engine 712 of system 700 provides the NLP-based interface for the AI-driven indexing framework created for probe-based backup systems. The user input from search nodes 704 is transmitted to the Santorini nodes 711 as complex queries on the metadata processed by NLP processes in AI engine 712. The search nodes 704 can conduct searches of the backup data and a catalog process 716 stores appropriate index data in databases 717, which is then processed through a differencing algorithm 718.

In system 700, a probe might be defined as any appropriate search parameter. For example, a probe may specify “find backup and index files where the access pattern exceeds 10% and the modified pattern exceeds 1% in a day.” The probe agents would periodically query these conditions, and if they are met, the probe is triggered.

System requirements for implementing the AI-driven indexing framework for backup files generally include a data storage infrastructure capable of handling large volumes of data, access to machine learning and NLP tools, and a system for extracting and managing metadata from backup files.

As shown in FIG. 7, metadata is collected from the data sources 702 by a centralized probe-based backup engine 712. In an embodiment, a data ingestion and metadata extraction subcomponent collects backup files from all of the nodes. During the probe-based backup process, client-specific agents integrated into the Santorini server collect key metadata such as Mtree structure, access patterns, change rates, file categories, sizes, and file types. This metadata is important for categorizing files for efficient indexing and retrieval, maintaining system-wide consistency across nodes.

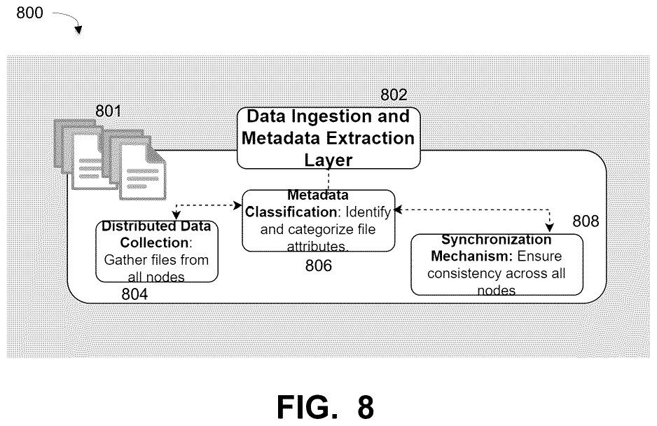

FIG. 8 illustrates a data ingestion and metadata extraction subcomponent, under some embodiments. As shown in FIG. 8, system 800 comprises a data ingestion and metadata extraction layer 802 that performs metadata classification 806 to identify and categorize file attributes for files 801 gathered from all nodes through a distributed data collector 804. A synchronization mechanism 808 ensures consistency across all nodes by imposing certain defined standards and rules.

The collected metadata, along with the file information, is processed and converted into vector representations, which are stored in an NLP vector database. This conversion enables fast, efficient, and accurate query execution by transforming metadata into a form that can be easily accessed and queried. Distributed processing frameworks ensure smooth data ingestion across multiple nodes, while synchronization mechanisms maintain consistency across the environment, enabling the system to maintain a global index for the entire backup system.

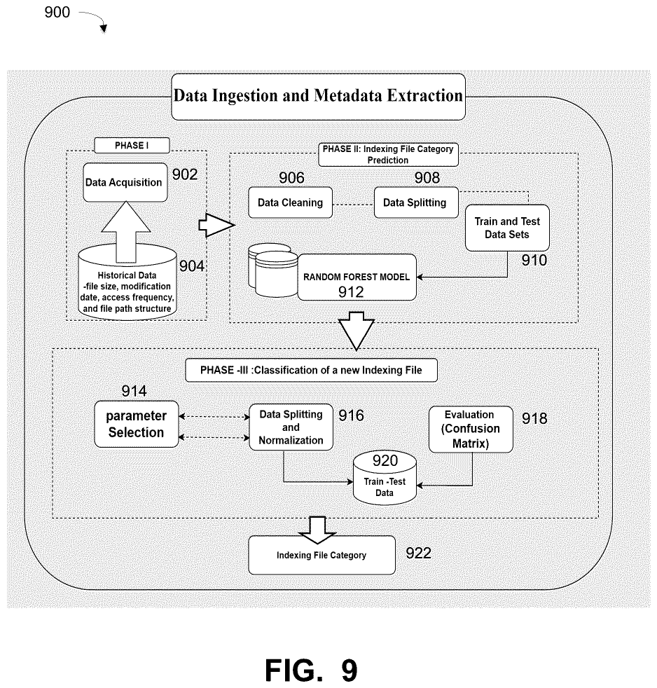

FIG. 9 illustrates a data ingestion and metadata extraction process, under some embodiments. Process 900 comprises three phases denoted Phase I, Phase II and Phase III, as shown. The first phase includes a data acquisition step 902 in which historical data including file size, modification data, access frequency, and file path structure 904 is collected. This acquired data is processed in the second phase, which provides indexing file category prediction. This phase includes data cleaning 906, data splitting 908 and training of test data sets 910. To optimize the extraction and classification of file attributes, the system leverages the Random Forest model 912, a powerful machine learning algorithm well-suited for handling large, heterogeneous datasets. In process 900, Random Forest is trained on features such as file type, data classification (e.g., critical data labelled as confidential, internal use, etc.), access patterns, change rates, ACLs (user/group), sizes, and file types, etc. The algorithm constructs multiple decision trees, each trained on a random subset of features, and combines their predictions to ensure accurate file classification. This reduces overfitting and enables the system to categorize and extract relevant metadata, even with new or rare file types. By continuously retraining the model with newly ingested backup data, the system adapts to evolving access patterns, ensuring accurate and up-to-date indexing.

The output from the Random Forest model 912 is processed in the third phase, which comprises a dynamic indexing engine that is designed to build adaptive and real-time indexing structures from the extracted metadata. This process continuously analyzes file access patterns, usage trends, and historical data to optimize the indexing process. It dynamically adjusts indexing strategies as new data is ingested, ensuring efficient searches even as access frequency and trends evolve. As shown in FIG. 9, this phase includes a parameter selection step 914, a data splitting and normalization step 916, and an evaluation step 918 that compiles the training and test data 920. The output from this phase comprises the indexed file category.

Besides Random Forest, other similar models can be used, such as support vector machines (SVM) and so on.

In an embodiment, the dynamic indexing engine 502 uses Long Short-Term Memory (LSTM) networks within the engine to predict future usage patterns. LSTMs are particularly effective in learning from sequential data, capturing temporal dependencies in file access behavior. By predicting future access trends, the system can proactively re-index files based on anticipated changes, adjusting priorities accordingly. The LSTM model is trained on historical access logs and metadata, enabling it to identify recurring patterns such as daily, weekly, or seasonal spikes in usage. This predictive approach allows the system to adapt the indexing process and improve retrieval efficiency.

Additionally, clustered indexes are maintained across distributed databases, ensuring synchronized indexing across all nodes. The dynamic indexing engine 502 also incorporates techniques for index fragmentation management, automatically restructuring or defragmenting the index to prevent inefficiencies caused by fragmented data.

To ensure the integrity and accuracy of the indexing process, the anomaly detection mechanism 512 continuously monitors file access logs and indexing behavior. This component identifies irregularities such as data corruption, unauthorized access, or improper file restoration that could compromise backup reliability. An embodiment uses autoencoders, advanced deep learning models, for anomaly detection. Autoencoders analyze file behavior by reconstructing normal access patterns and detecting deviations when reconstruction errors occur. When anomalies are detected, alerts are triggered, and the system takes corrective actions to maintain indexing accuracy and data integrity. Real-time monitoring ensures that anomalies are detected and addressed promptly, enhancing the reliability of recovery points.

The anomaly detection process works in close collaboration with the dynamic indexing engine 502, allowing the system to adjust indexing strategies based on detected anomalies, ensuring efficient data retrieval even in large-scale, multi-node environments.

Embodiments use an NLP interface 506 as a user-centric component that enables intuitive interaction with the backup system. By allowing users to perform searches using natural language queries, this interface enhances both the accessibility and efficiency of the backup system. Users can easily retrieve backup files by simply asking questions like, “Find all files modified last month related to project X,” thus removing the need for complex query structures. The interface leverages NLP models, such as BERT (Bidirectional Encoder Representations from Transformers), which are pre-trained to understand the nuances of human language. BERT excels at understanding context, sentence structure, and word relationships, making it ideal for interpreting complex user queries. When a query is submitted, the NLP interface 506 processes it by extracting key terms and identifying the core intent. Query expansion techniques are applied to include related terms and synonyms from the indexed metadata, ensuring comprehensive and relevant results even with vague or incomplete queries.

To enhance search accuracy, the interface employs semantic search capabilities 514 to understand the context behind queries and incorporating synonyms, variations, or industry-specific terminology. Results are ranked using relevance algorithms, such as TF-IDF or cosine similarity, ensuring that the most relevant files are prioritized in search results.

By integrating NLP techniques, the interface enables efficient, intuitive search capabilities, making it easier for users to retrieve backup data and improving overall system usability. In an embodiment, the search mechanism is designed to interpret natural language queries, parse them into structured components, and return relevant results based on contextual understanding, rather than exact matches.

FIG. 10 illustrates an NLP interface and operation, under some embodiments. As shown in diagram 1050, nodes 1051 provide metadata (e.g., data classification, access patterns, change rates, ACLs, file size, file types, etc.) in the form of elastic search database (ESDB) or SQL information to a lightweight NLP engine 1056 for storage in NLP vector database 1058, which together form NLP complex queries 1054. These queries are generated for natural language search strings input by a user to the search engine 1057 and processed by the NLP engine 1056.

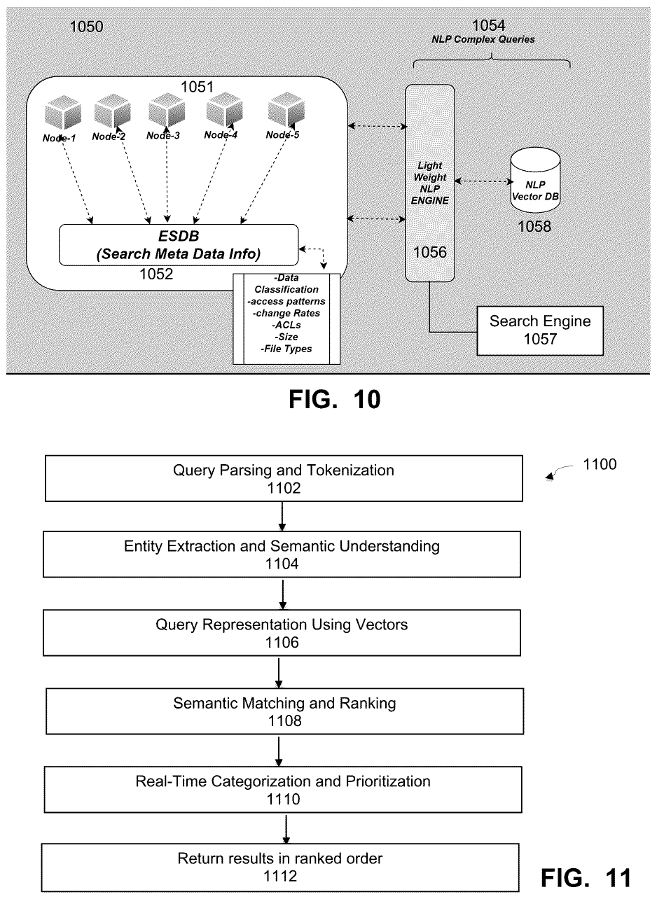

FIG. 11 is a flowchart illustrating a method of retrieving files using AI-driven intelligent indexing, under some embodiments. For this process, a user query is input from a search node (e.g., 704) to the AI engine (e.g., 712) as an NLP complex query. The process 1100 performs query parsing and tokenization on the input text, 1102. As an example case, consider the query: “Find financial reports from Q3 2023.” Step 1102 involves query parsing and tokenization to break it down into tokens (key units). The NLP engine 1056 identifies parts of speech and key entities in the query using algorithms like spaCy or BERT for this purpose.

During tokenization, the sentence is split into discrete tokens, such as: “Find,” “financial,” “reports,” “from,” “Q3,” “2023.” Next is Part-of-Speech (POS) tagging where each token is labeled with its grammatical role: “Find” (verb), “financial” (adjective), “reports” (noun), “Q3” (entity), “2023” (entity). Next is Named Entity Recognition (NER), where the NLP engine 1056 recognizes named entities (specific information like dates, product names) so that “Q3” is recognized as the third quarter of a year, and “2023” is the year entity, for example.

After tokenization, the system performs entity extraction to identify and understand the key entities relevant to the query, 1104. In this step, the semantic layer of the NLP model interprets these entities to assign meaning. For the example, “financial reports” is recognized as the file type for which the user is looking, and “Q3 2023” is mapped to a time period (third quarter of the year 2023). The NLP engine understands this to mean files that were created or modified between Jul. 1, 2023, and Sep. 30, 2023. This interpretation is made possible using pretrained embeddings like Word2Vec or BERT models, which enable the system to understand the relationships between words.

Once the NLP engine has identified and interpreted the key entities, it converts the query into a vector representation, 1106. This involves generating numerical embeddings for the words and entities in the query based on pretrained language models. For semantic matching and ranking, 1108, the search engine compares the vectorized query to the vectors representing backup files. Using techniques like cosine similarity, the system calculates how similar the query vectors are to the vectors of the files stored in the system.

Cosine similarity measures the angle between two vectors, with a value closer to 1 indicating greater similarity, as given in the following equation below.

$$Cosine Similarity ( {v}_{query} , {v}_{file} ) = \frac{{v}_{query} \cdot {v}_{file}}{‖ {v}_{query} ‖ ‖ {v}_{file} ‖}$$

For example, if the system is comparing the query vector for “financial reports Q3 2023” against a vector representing a file named “finance_q3_report.pdf”, the similarity score might be very high, such as 0.95, meaning the file is highly relevant. In contrast, files with less relevance (e.g., older financial documents) might have lower similarity scores, such as 0.65.

In addition to semantic matching, the system also uses a classification algorithm (e.g., Random Forest) to prioritize the search results based on file usage patterns and access frequency, 1110. The engine might prioritize files that have been frequently accessed in recent months or that are part of high-priority datasets.

Once the relevant files are identified, the system returns them in a ranked order, starting with the most relevant based on similarity scores, 1112. Additionally, the NLP system may generate a natural language summary for each result, further enhancing the user's understanding. An example of such an output may be “for File: finance_q3_report.pdf: This file contains financial reports for Q3 2023, last modified on September 28, 2023.”

FIG. 11 shows an embodiment in which the output comprises text output of the results responsive to the query. The output may be any appropriate message response or even retrieval of the identified files themselves. Thus, the returned file information may be a yes or no message that a file responsive to a search query has been located, a list of one or more files responsive to the search query, or retrieval of the one or more files.

To efficiently handle compute and manage large-scale data retrieval, the overall system 1050 implements a lightweight search engine that interacts with the NLP vector database 1058. Rather than storing the vector database directly within the Santorini system, the search engine easily queries this external NLP vector database, which contains the metadata in vectorized form. This allows the system to simplify the querying process for users, enabling natural language queries to be processed effortlessly.

When a user submits a query, the search engine passes the relevant information to the NLP vector database 1058, which then performs the necessary retrieval operations. The data is extracted from the nodes 1051 where it resides, ensuring fast and accurate results. This approach minimizes the computational load on the Santorini server, leveraging the external NLP vector database and search engine for efficient data retrieval, while maintaining a responsive and scalable backup system.

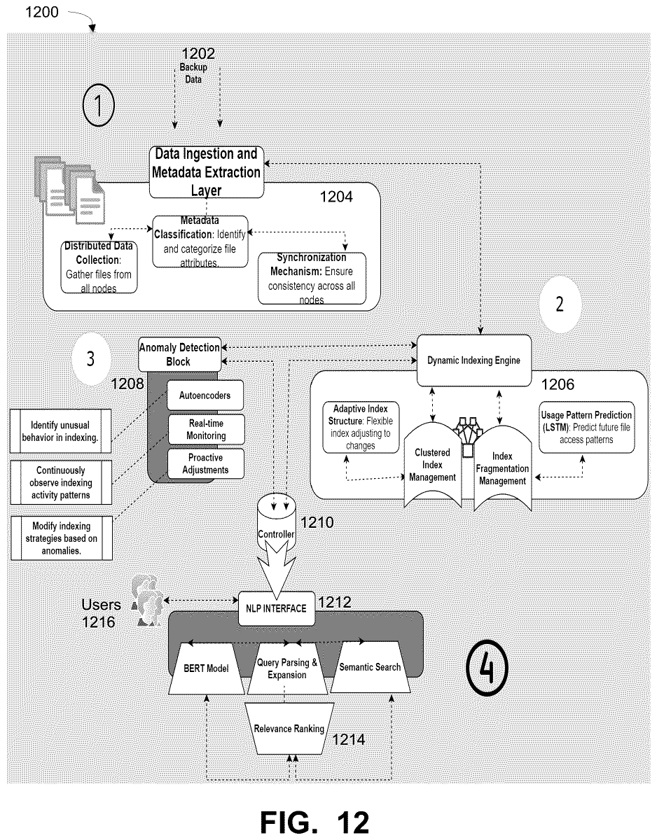

FIG. 12 illustrates an overall intelligent indexing system for probe-based backups in a clustered system, under some embodiments. As shown in FIG. 12, system 1200 receives backup data 1202 into a data ingestion and metadata extraction layer 1204 that performs (in step 1) the steps of distributed data collection, metadata classification, and synchronization, as described above with respect to system 800 of FIG. 8.

The extracted metadata from layer 1204 is input to the dynamic indexing engine 1206 that comprises an adaptive indexing structure that produces a flexible index (in step 2) that adjusts to changes, a clustered index manager, a usage pattern prediction (LSTM) component, and index fragmentation management.

The index from the dynamic indexing engine 1206 is provided (in step 3) to an anomaly detection block 1208 that comprises autoencoders, real-time monitoring, and proactive adjustments to continuously observe indexing patterns, identify unusual indexing behavior, and modify indexing strategies based on anomalies.

The indexes from indexing engine 1206 and modified indexes from the anomaly detection block 1208 are input to a controller 1210, which is then input to an NLP interface 1212. This interface comprises a BERT model, query parsing and expansion, and semantic search capabilities to produce (in step 4) a relevance ranking of search results, 1214.

System 1200 provides an AI-driven indexing framework for probe-based backup systems, enabling intuitive, context-aware search and real-time metadata categorization using natural language processing. It also integrates continuous improvement through a feedback loop and anomaly detection to ensure data integrity and optimize operational efficiency in multi-node environments. Overall, the system provides enhanced search efficiency through an adaptive indexing system that optimizes search results by dynamically re-indexing files based on real-time access patterns. This ensures faster file retrieval in large multi-node environments. It also provides user-friendly interaction in that the NLP interface allows users to search for files using natural language queries, simplifying the search process and improving accessibility for non-technical users. The integrated anomaly detection mechanism proactively identifies and resolves indexing issues such as data corruption or unauthorized access, ensuring accurate and reliable data recovery.

Self-Learning with Reinforcement Learning

As mentioned above, as data volumes in multi-node backup systems continue to grow, traditional indexing methods fail to keep pace with the scale and complexity of modern datasets. These systems lack the ability to adapt to changing access patterns and usage trends, resulting in inefficient resource utilization and slow file retrieval times, which is a critical issue in cases for time-sensitive recovery situations.

Embodiments of system 100 of FIG. 1 include a self-learning module 132 that leverages Reinforcement Learning (RL) to dynamically optimize indexing strategies and improve retrieval efficiency in multi-node backup systems. This module integrates with the existing AI-driven framework of the intelligent indexing process 112 to enable continuous adaptation to evolving data patterns.

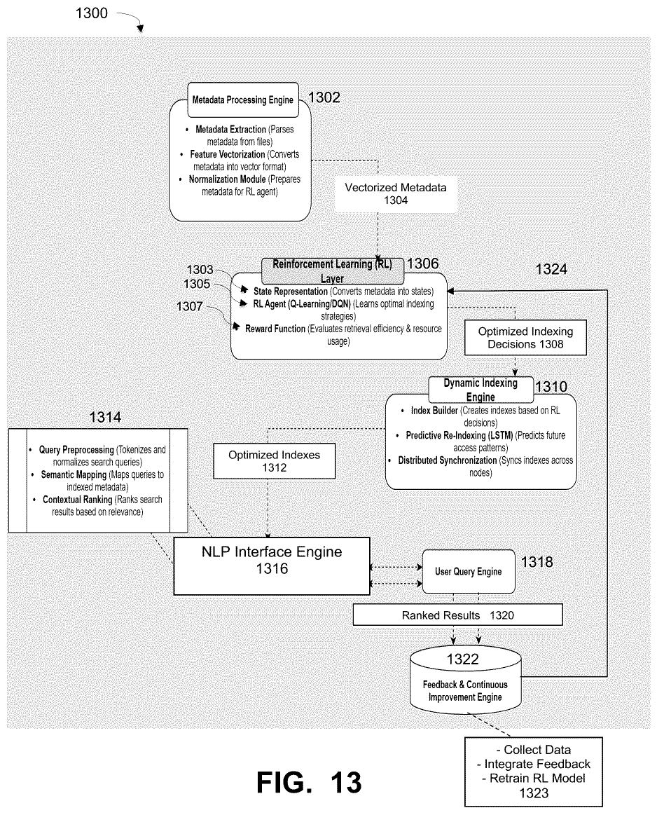

FIG. 13 illustrates a reinforcement learning module for intelligent dynamic indexing, under some embodiments. As described above, the real-time indexing strategy adapts to changing data patterns, ensuring efficient search and retrieval by continuously updating the index based on access trends and usage behavior.

As shown in FIG. 13, a metadata processing engine 1302 extracts metadata parsed from files (as described for embodiments above), converts the metadata into a vector format, and prepares the metadata for an RL agent through a normalization process. The resulting vectorized metadata 1304 is input to RL layer 1306, which enables the system to make optimal indexing decisions by learning from interactions with the environment. The data specific RL layer 1306 is used to train the system to adaptively index files based on real-time data patterns. This involves the four main phases of (1) defining the environment, (2) representing states, (3) designing actions, and (4) creating reward functions. The environment defined in phase 1 consists of the backup system's metadata, including file access patterns, change rates, file categories, and resource utilization metrics. The states in phase 2 are represented as feature vectors derived from metadata, such as access frequency, file priority, and resource usage. The actions designed in phase 3 include decisions like prioritizing specific files for indexing, adjusting indexing frequency, and allocating resources to high-priority tasks. The rewards created in phase 4 are defined based on retrieval efficiency, resource utilization, and user satisfaction.

As shown in FIG. 13, RL layer 1306 a state representation component 1303 to convert the metadata 1304 into states. Process 1306 uses a Q-Learning or Deep Q-Networks (DQN) algorithm, where the RL agent 1305 learns a policy that maps states to actions, maximizing cumulative rewards over time. The agent balances exploring new indexing strategies and exploiting known optimal strategies using techniques like &-greedy policies through a reward function 1307.

The output of the RL layer 1306 comprises optimized indexing decisions 1308 that are fed into a dynamic indexing engine 1310 that creates indexes based on RL decisions, predicts future access patterns (e.g., through LSTM), and syncs indexes across nodes. The resulting optimized indexes 1312 are input to a NLP interface engine 1316 that performs tasks 1314, such as query preprocessing, semantic mapping, and contextual ranking. As described above, the NLP engine understands, interprets, and responds to human language, allowing users to interact with the backup system using natural language queries input to the user query engine 1318. Through the interface of the user query engine 1318, the NLP interface engine 1316 returns ranked results 1320, such as described above with respect to FIG. system 1200 of 12.

For the embodiment of FIG. 13, system 1300 includes a feedback loop control for continuous refinement. This function captures user interactions and system performance data, refining the RL model in RL layer 1306 for continuous improvement. The feedback engine 1322 performs functions 1324, which include collecting data such as user search logs, system performance metrics, and anomaly detection data that are then aggregated together. Engine 1322 also integrates user feedback that is used to adjust the reward function, while performance metrics fine-tune the RL agent's policy. The RL model is also periodically retrained using updated data to ensure it remains adaptive to evolving patterns.

In an embodiment, feedback engine 1322 uses certain log aggregation tools, such as ELK Stack (Elasticsearch, Logstash, Kibana) for collecting and analyzing logs, RL framework tools such as OpenAI Gym or Stable-Baselines3 for RL model training and evaluation. These are just some examples of possible tools, and others may also be used.

Information from the feedback component 1322 is fed back to the RL layer 1306 over feedback loop 1324. As shown in FIG. 13, the RL layer 1306 is in sync with the feedback and continuous improvement engine 1322 through this feedback loop. At the backend, this improvement engine is connected to a policy segment 1323 and hence can be updated continuously with time through the tasks of collecting data, integrating feedback, and retraining the RL model.

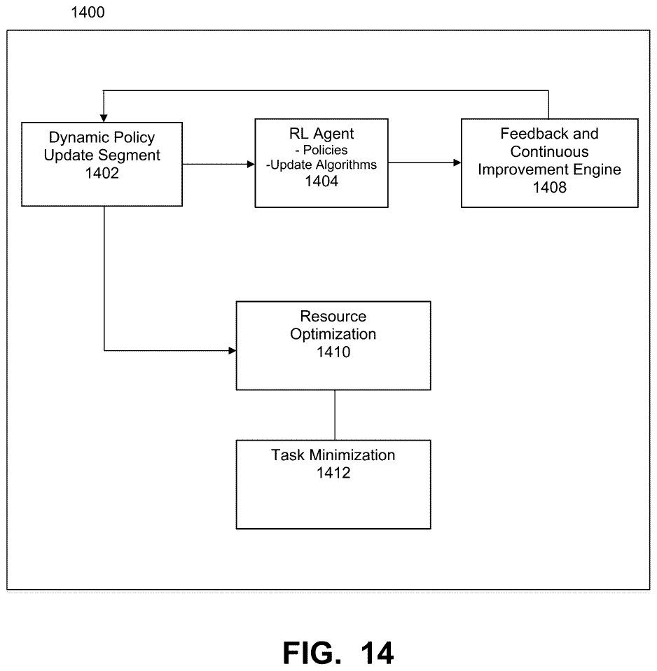

FIG. 14 illustrates continuous update of RL model policies using feedback, under some embodiments. In an embodiment, the refined RL model and updated policies are passed to a dynamic policy update segment for real-time adaptation. The update segment dynamically adjust the RL agent's 1305 policies based on real-time data adaptability to changing access patterns, and as provided from the feedback and continuous improvement engine 1322. This component evaluates a current policy using metrics like retrieval efficiency and resource utilization, which are then used to improve policies. The RL agent 1305 updates its policies using algorithms, such as Policy Gradient or Proximal Policy Optimization (PPO). The system continuously monitors incoming data streams and adjusts policies in real-time. The updated policies are then sent to the resource optimization module to ensure efficient resource allocation.

In an embodiment, system 1400 also includes a resource optimization module 1410 that minimizes resource consumption by optimizing indexing operations and focuses on high-priority files. For this component, files are categorized into priority levels (e.g., high, medium, low) based on access patterns and metadata. Based on these priority levels, resources (e.g., CPU, memory, etc.) can be allocated dynamically based on indexing priorities.

In a further embodiment, redundant indexing tasks can be identified and minimized through a tasks minimization component 1412. The system can implement distributed computing frameworks (e.g., Apache Spark or Hadoop) for scalable resource allocation, and load balancers (e.g., Kubernetes or Docker Swarm) for managing resource distribution.

Embodiments thus provide a self-learning system that dynamically optimizes indexing strategies in real-time, adapting to evolving data patterns and usage trends in multi-node backup environments leveraging RL. The system dynamically adjusts indexing strategies based on real-time data patterns, ensuring efficient retrieval even as access trends evolve. By focusing on high-priority files and reducing redundant tasks, the module minimizes resource consumption. The self-learning capability ensures faster and more accurate file retrieval, especially during time-sensitive recovery operations.

In an embodiment, the intelligent indexing process 112 utilizes certain artificial intelligence (AI) and machine learning (ML) processes to evaluate metadata to generate a model and classify indexes accordingly. Such a process generally uses a training component that continuously trains a machine learning algorithm.

Embodiments of the processes and techniques described above can be implemented on any appropriate backup system operating environment or file system, or network server system. Such embodiments may include other or alternative data structures or definitions as needed or appropriate. The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

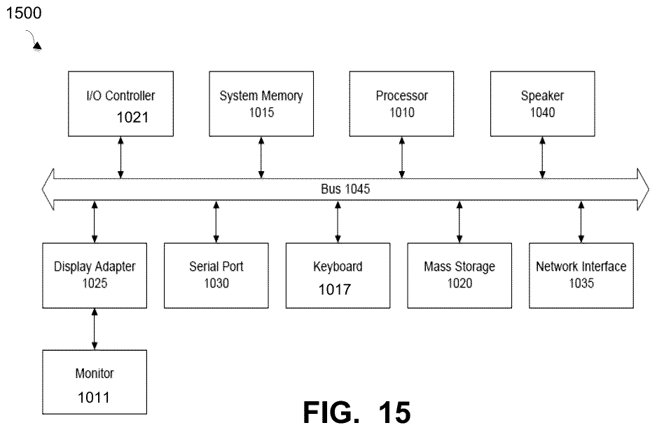

The network of FIG. 1 may comprise any number of individual client-server networks coupled over the Internet or similar large-scale network or portion thereof. Each node in the network(s) comprises a computing device capable of executing software code to perform the processing steps described herein. FIG. 15 is a block diagram of a computer system used to execute one or more software components of the processes described herein, under some embodiments. The computer system 1500 includes a monitor 1011, keyboard 1017, and mass storage devices 1020. The computer system further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. The processor 1010 may include multiple processors or a multicore processor, which may permit parallel processing of information. Computer system 1500 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac™ OS X, IRIX32, or IRIX64. Other operating systems may be used.

Embodiments can include computer-readable storage medium containing computer-readable instructions or computer program code. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Although certain embodiments have been described and illustrated with respect to certain example network topographies and node names and configurations, it should be understood that embodiments are not so limited, and any practical network topography is possible, and node names and configurations may be used.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). A network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but other sequences may be possible and some may be performed in parallel. Additionally, steps may be subdivided or combined. As disclosed herein, software written in accordance with the present invention may be stored in some form of computer-readable medium, such as memory or CD-ROM, or transmitted over a network, and executed by a processor.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of retrieving file information responsive to searches in a distributed network, comprising:
receiving the query as a complex plain language input received through a search engine interface from the user to retrieve file information from backup data sourced by a plurality of nodes in the distributed network;
performing natural language processing (NLP) on the query to extract metadata from the file information;
dynamically indexing the metadata using a machine learning (ML) system performing real-time categorization and prioritization of data of the accessed files based on access frequency and usage trends to build a real-time index from the metadata;
continuously collecting data about access trends and system usage behavior;
modifying the index using the collected data to adapt the indexing to changing data patterns; and
retrieving the file information using the index, wherein the distributed network comprises a Santorini network of individual nodes having a log-structured file system implemented in a Data Domain Filesystem, and wherein the namespace contains file metadata implemented as a layered KVS, and further wherein the Santorini network comprises stateless independent Data Domain services processing containerized data utilizing a Kubernetes-based framework, and comprises part of a Data Domain deduplication backup system performing backup and restore operations for the plurality of nodes and stores file system metadata and a fingerprint index in the KVS.

2. The method of claim 1 further comprising converting the metadata into a vector representation for storage in a NLP vector database to produce vectorized metadata.

3. The method of claim 2 wherein the data is continuously collected by a feedback engine functionally coupled to a reinforcement learning (RL) component providing input for the dynamic indexing step.

4. The method of claim 3 wherein the RL component converts the vectorized metadata into states, and comprises an RL agent that learns optimal indexing strategies through, and a reward function that evaluates retrieval efficiency and system resource usage.

5. The method of claim 4 wherein the RL agent employs a Deep Q-Network (DQN) that maps the states into actions using a policy, and maximizes cumulative rewards over time.

6. The method of claim 3 further comprising detecting anomalies by learning efficient representations of data and identify deviations from defined normal patterns.

7. The method of claim 6 wherein the feedback engine comprises a log aggregation tool to collect and aggregate user search logs, system performance metrics and anomaly detection data for the continuous collecting step.

8. The method of claim 5 further comprising a dynamic policy update segment that is configured to dynamically adjust the RL agent policy to facilitate adaptability to changing access patterns.

9. The method of claim 8 further comprising prioritizing files of the backup data into priority levels based on access patterns and respective metadata, and further wherein the dynamic policy update segment sends updated policies to a resource optimization module that processes files in order of priority to minimize resource consumption.

10. The method of claim 1 further comprising performing a semantic search to return the file information, wherein the file information comprises one of a yes/no message that a file responsive to a search query has been located, a list of one or more files responsive to the search query, or retrieval of the one or more files.

11. The method of claim 1 wherein the NLP processing utilizes a pre-trained Bidirectional Encoder Representations from Transformers (BERT) model to analyze nuances of the plain language query by analyzing context, sentence structure, and word relationships in the query, the method further comprising expanding the query by including related terms and synonyms from indexed metadata.

12. The method of claim 1 wherein the index is produced using a long-short term memory (LSTM) network to predict future usage patterns from sequential data capturing temporal dependencies in file access behavior, and wherein the LSTM is trained on historical metadata to identify recurring patterns with respect to usage spikes.

13. (canceled)

14. A system for retrieving file information responsive to searches in a distributed network, comprising:
an interface receiving the query as a complex plain language input received through a search engine interface from the user to retrieve file information from backup data sourced by a plurality of nodes in the distributed network;
a natural language processing (NLP) engine performing natural language processing on the query to extract metadata from the file information;
an indexer dynamically indexing the metadata using a machine learning (ML) system performing real-time categorization and prioritization of data of the accessed files based on access frequency and usage trends to build a real-time index from the metadata;
a feedback engine continuously collecting data about access trends and system usage behavior; and
a reinforcement learning agent modifying the index using the collected data to adapt the indexing to changing data patterns, wherein the distributed network comprises a Santorini network of individual nodes having a log-structured file system implemented in a Data Domain Filesystem, and wherein the namespace contains file metadata implemented as a layered KVS, and further wherein the Santorini network comprises stateless independent Data Domain services processing containerized data utilizing a Kubernetes-based framework, and comprises part of a Data Domain deduplication backup system performing backup and restore operations for the plurality of nodes and stores file system metadata and a fingerprint index in the KVS.

15. The system of claim 14 wherein the metadata is converted into a vector representation for storage in a NLP vector database to produce vectorized metadata, and wherein the RL agent converts the vectorized metadata into states, learns optimal indexing strategies through, evaluates retrieval efficiency and system resource usage through a reward function, and further wherein the RL agent employs a Deep Q-Network (DQN) that maps the states into actions using a policy, and maximizes cumulative rewards over time.

16. The system of claim 15 further comprising an anomaly detector detecting anomalies by learning efficient representations of data and identify deviations from defined normal patterns.

17. The system of claim 16 wherein the feedback engine comprises a log aggregation tool to collect and aggregate user search logs, system performance metrics and anomaly detection data for the continuous collecting step.

18. The system of claim 17 further comprising a dynamic policy update segment that is configured to dynamically adjust the RL agent policy to facilitate adaptability to changing access patterns, and wherein files of the backup data are prioritized into priority levels based on access patterns and respective metadata, and further wherein the dynamic policy update segment sends updated policies to a resource optimization module that processes files in order of priority to minimize resource consumption.

19. (canceled)

20. A method of retrieving file information responsive to searches in a distributed network, comprising:
accessing backup data sourced by a plurality of nodes in the distributed network and responsive to a search query input by a user;
extracting metadata from the backup data;
converting the metadata into a vector representation for storage in a vector database;
classifying the metadata with respect to file attributes based on defined characteristics;
dynamically indexing the metadata using a machine learning (ML) system performing real-time categorization and prioritization of data of the accessed files based on access frequency and usage trends; and
modifying the indexing based on continuously collected data about access trends and system usage behavior, and a reinforcement learning model using the collected data to adapt the indexing to changing data patterns, wherein the distributed network comprises a Santorini network of individual nodes having a log-structured file system implemented in a Data Domain Filesystem, and wherein the namespace contains file metadata implemented as a layered KVS, and further wherein the Santorini network comprises stateless independent Data Domain services processing containerized data utilizing a Kubernetes-based framework, and comprises part of a Data Domain deduplication backup system performing backup and restore operations for the plurality of nodes and stores file system metadata and a fingerprint index in the KVS.
